(19) United States
(12) Patent Application Publication
(10) Pub. No.: US 2011/0172955 A1
(43) Pub. Date: Jul. 14, 2011

(54) METHOD AND DEVICE FOR IDENTIFYING OBJECTS

(75) Inventors: Jürgen Herrmann, Rosenheim (DE); Alois Monzel, Morstadt (DE)

(73) Assignee: KHS GmbH, Dortmund (DE)

(21) Appl. No.: 13/120,194

(22) PCT Filed: Oct. 29, 2009
(86) PCT No.: PCT/EP2009/007748

§ 371 Date: Mar. 22, 2011

(30) Foreign Application Priority Data
Oct. 31, 2008 (DE) 10 2008 054 109.5

(51) Int. Cl. G06F 19/00

(52) U.S. Cl. 702/155

(57) ABSTRACT

The invention relates to a method and to a device for identifying objects (1), particularly machines, consumer items, such as bottles (1), and to parts thereof. To this end, a surface of the affected object (1) is scanned entirely, or at least in the area of a partial surface (8), wherefrom at least one result is derived. According to the invention, the natural surface of the object under inspection (1) is converted to digital characteristic values, wherein the said digital values are compiled into at least one key (9, 10).

The invention relates to a method and a device for identifying objects, in particular machines, consumer items such as bottles as well as parts hereof, according to which method a surface of the relevant object is scanned entirely or at least in the region of a part surface and at least one result is derived herefrom.

Methods of identification of the afore-described type are known in practice and are also described in DE 102 02 517 A1. This document deals with a machine for checking the wall of a bottle that has a surface decoration made up of lines. To this end, a two-dimensional camera is realized that represents an image as a pixel field. Over and above this, there is a device for scanning the pixels and for determining a region of selected pixels in which there is a pixel threshold. When a predetermined value is exceeded, a bottle reject signal is derived from the image conditions. The idea here is that if a bottle actually has defects, it is rejected in this manner.

Such defects here may be bubbles, bubbling or even stones in the glass. At the same time, however, the known method of operation requires the presence of a two-dimensional or three-dimensional surface decoration on the surface, which has to be applied in addition. This is costly and could possibly be impaired by additional defects. This is where the invention fits in.

The technical problem underlying the invention is to develop further a method of this type for identifying objects in such a manner that the system-specific and process-specific complexity is reduced to a minimum.

To solve this technical problem, a generic method for identifying objects within the framework of the invention is characterized in that at least one part surface of the natural surface is converted into characteristic digital values, which are combined together to form at least one key.

Therefore, according to the invention it is not the surface of the object to be examined, after having been manipulated in all sorts of ways, that is to be scanned, but rather the object as such with its natural surface, that means the surface originating during its actual production process, it being possible for said surface to be both machined and unmachined.

In other words, within the framework of the invention, the surface is not provided, for example, with decorations or other inhomogeneities nor is it processed in any way for preparation of the intended scanning, but rather is scanned such that it is as it is after the production process of the relevant object. There can obviously also be an application of colour in this case. The decisive factor here is that the surface does not experience any additional artificial processing in preparation for its identification, but rather is examined and scanned as it is once the object has been produced. Said natural surface can consequently be, for example, the surface of a casting part, a mechanically processed surface, a painted or chromium-plated surface, or also a radiated surface. Said natural surface is then converted into one or more characteristic digital values.

Within the framework of the invention this means that characteristics of the natural surface are scanned and determined in order to derive herefrom the measuring values that correspond, in their turn, to characteristic digital values for the surface. Said one or more digital values are then combined to form a key, which is unique to the relevant surface of the object and at the same time represents a “finger print” of the surface and, as a result, characterizes the object as such in a unique manner.

The characteristics of the surface of the object to be examined scanned in this manner can, for example, be its structural conditions, its surface finish or surface finish parameters, the colour or colour combination, the reflection behaviour, the transparency of the object, its strength, etc. In principle, along with these optical and mechanical characteristics described, electrical characteristics can also be evaluated such as the ohmic and also capacitive resistance of the surface or at least of a part surface. Determining the chemical characteristics of the surface and its characterisation thereby is also conceivable. Thus, for example, the adsorption capacity or even the oxidation capacity can be evaluated and be utilized for the unique characteristic identification in terms of the key.

The invention always proceeds from the basic principle and knowledge that it is possible to differentiate between the surfaces of, in principle, identical objects if sufficient precise observation is carried out . This already applies in part to the macroscopic area and more than ever to observations and examinations in the microscopic area. This leads to the fact that in a final analysis there are no two objects that have an identical surface under the afore-described conditions. As a consequence, the surface or certainly at least a part surface of the surface of the relevant object can be used for its unique identification by means of the key derived from the digital value or values.

This means that the key combines the one or the many digital values together which, with consideration to one (or more) previously selected surface characteristic(s), correspond to measuring values of the examined surface or part surface. If, for example, the surface finish of the object to be examined is selected as the characteristic, this means that, in the example here, the surface finish distribution of the object to be examined is examined and evaluated over a previously selected and defined part surface. Said surface finish distribution is them converted into a key. This means that the key represents an image of the selected part surface examined or of the entire surface of the object, in such a manner that, in the example here, the frequency of the individual surface finish values at the associated site is imaged. In this context, in the majority of cases a part surface that corresponds to a unique key is used. Thus, part surfaces of ca. 1 cm² or more have proved favourable for measuring the surface finish. The key derived herefrom is then identified as a reference key and is stored, for example, in an external data base. In this way the object examined obtains a unique identification.

As an alternative to this or in addition, the relevant key can also be attached to the identified object. At this point the invention recommends imaging the reference key in a label or a marking etc that is attached to the object. In the event that the object examined is, for example, a consumer item, the reference key can be stored directly in a label attached in any case to said item or in the barcode that is provided in the majority of cases.

It can be ascertained without any doubt in this manner whether the label, and as a consequence also the packaging of the object, is associated originally with the object. This means that the originality of the packaging, including its content, can be proven uniquely and in a tamper-proof manner, without having to have recourse to an additional external data base. This is especially significant for sensitive, for example perishable goods and even to other high-value products that have to be protected from tampering (for example medicines, foodstuff or even fluids for operating machines, etc).

Over and above this, the object as such can be provided with identification in this manner as well as with an associated closure. This means that the togetherness of object and closure or packaging and closure can be established by means of the associated key for, on the one hand, the object and its packaging and, on the other hand, its closure, one or more keys being able to be stored therein. In the majority of cases, in such a case there would be one key for the relevant consumer item, which includes, on the one hand, the key for the closure and, on the other hand, the key for the rest of the object or the container. This means the closure and container are interconnected to form an inseparable unit and it can be directly established whether, for example, the closure has been replaced or not.

This measure also contributes to the fact that the originality of the examined object or consumer item can be proven. In each case, for example, the manufacturer of the consumer item or generally speaking of the object to be examined is always in a position to account for the unique provenance of the object by means of the reference key, either on the object and/or additionally stored, as quasi originality evidence. In this case, it is clear that the key or reference key can be supported by additional data, such as for example the date of manufacture, the test date, the batch number etc . . .

This means that the key and the reference key derived herefrom give extensive information on the product identified in such a manner with regard to its individual (surface) characteristics, possibly its date of manufacture, the place of manufacture, the manufacturer, where applicable the materials used, etc. By means of such originality evidence, at a subsequent time the key or rather reference key can be determined or verified or falsified through renewed analysis of the container or of the bottle or generally speaking of the object to be examined.

For a comparison between the newly determined key or the so-called check key and the reference key stored in the data base and/or on the object leads to a result such that either both keys match or they do not. In this manner the object can be verified as the original by the data base interrogating the reference key stored there or the label located on the object or a marking with the reference key stored therein being read-out and compared with the check key.

Such a method of operation has particular importance to not only, for example, consumer objects or generally speaking to consumer goods and their identification and to originality evidence, but also to machines and their parts (replacement parts, wearing parts etc.) which can be checked for originality and provenance. Depending on whether the scanning of the surface with the check key derived therefrom leads to a match with the reference key or not, a clear statement can be made as to whether or not, for example, the replacement part or wearing part is an original manufacturer's part or a copy.

In this case the procedure is generally such that the degree of conformity between the check key and the reference key must exceed a predetermined value. Any surface changes brought about by use, contamination etc, for example, can be taken into consideration in this way. This means that as soon as, for example, there is in excess of an 80% or 90% match between the check key and the reference key, this will be interpreted as evidence of originality and can be used. This means that a 100% match between the reference key and the check key is not necessary, simply a value that has been predetermined beforehand has to be exceeded in order to be able to produce a relatively high level of probability of a match between the objects or keys to be compared.

One possibility of establishing this match is to specify the so-called hamming distance, that is to say the number of the bits in which the two keys are (still) allowed to differ. Generally speaking, the conformity of the character chains stored in the keys (check key and reference key) is checked. In this case, the keys are compared bit by bit. The number of positions that differ is counted and evaluated as the hamming distance.

It is possible to determine the surface and to derive a result from the relevant scanning in a completely different manner. Thus, it is possible both to scan the surface by means of contact, that is in a tactile manner, and also to scan it in a contactless manner. It is obviously also possible to combine the two where applicable. In the first-mentioned case, the scanning unit is designed as a tactile device and operates, for example, as a stylus instrument.

Such a stylus instrument regularly has a stylus tip made, for example, from a diamond, which is moved at constant speed over the surface of the object to the detected. An individual measuring profile or roughness profile of the scanned object can be derived from the inevitable vertical positional displacement of the stylus tip caused by the scanned surface roughness. To this end, the movements of the stylus tip are detected, for example, by means of an active path measuring system.

Over and above this, the scanning of the surface can be effected in a contactless manner, which is carried out in the majority of cases by means of an optical measuring unit for the contactless measuring of deviations in form and/or shape. In this case, the invention, as a rule, applies so-called conoscopic holography, which is based on the interference of two coherent light waves. In this case, a light point is created on the object to be tested by means of a laser beam, the light of said light point being reflected quasi in all directions. Part of the light reflected by said light point is detected by a lens unit, by means of which transmitted light is superposed and, with regard to its interference, evaluated. In this case, the measuring process is based on the reconstruction of the spacing of the light point from the angular data being produced therefrom.

In each case the scanning unit has associated therewith a comparator, which compares the reference key of the already scanned object with a check key, which is derived from the object currently being examined. Depending on whether or not the comparator establishes a match between the reference key and the check key with consideration to admissible deviations or to the already referred to hamming distance, it is possible, or not, to conclude that the object examined is original, or is not original.

As a result, a method and a device are made available, by means of which the objects examined are provided with a unique identification. To this end, at least a part surface of the respective surface of the object is scanned and characteristic digital values are derived from said scanning, said digital values being combined together to form at least one key. In this context, the invention uses the natural surface of the object in each case and in an exclusive manner no surface markings etc are necessary.

The key determined, for example, during the production of the object is stored in a data base and/or directly on the object as the reference key. This means that the originality of the object can be evidenced at any time and any tamperings with the object are easy to establish. These are the essential advantages of the invention.

The invention is described below by way of a drawing that represents just one exemplary embodiment, in which, in detail:

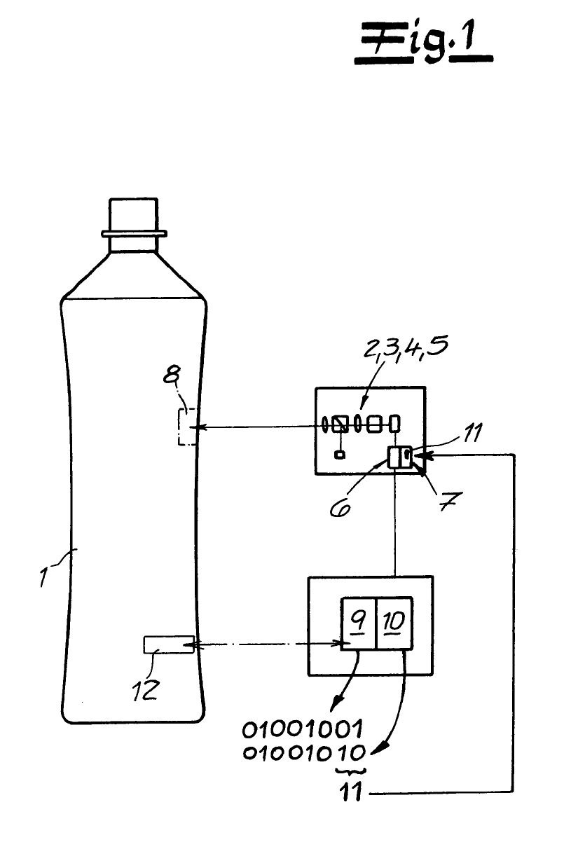

FIG. 1 shows a schematic representation of the device according to the invention,

FIG. 2 shows the scanning unit in detail and

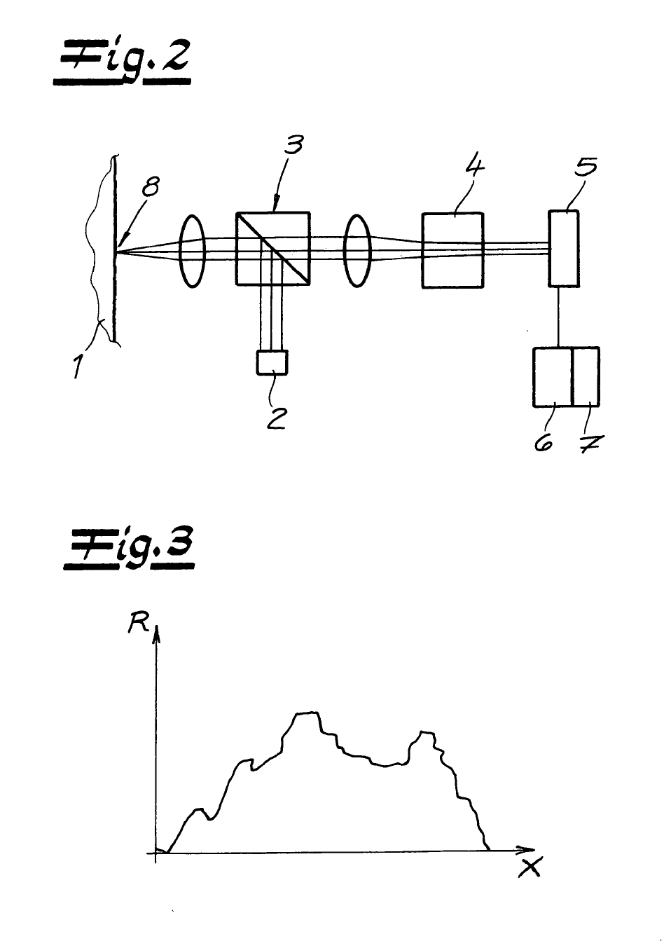

FIG. 3 shows a method of operation for determining the key.

FIG. 1 represents a device for identifying objects 1. The objects to be identified, in the example here and in a non restrictive manner, are bottles 1. For identifying the object or the bottle 1, the device has a scanning unit 2, 3, 4, 5, which is represented in detail in FIG. 2. Along with said scanning unit 2, 3, 4, 5 there is also an identification device 6 for deriving at least one result from the measurements for scanning the surface of the object or bottle 1. In addition, there is a comparator 7, which in the exemplified embodiment is incorporated into the identification device 6 or a forms one structural unit 6, 7 together with the identification device 6.

The method of operation is as follows. By way of the scanning unit 2, 3, 4, 5, the object to be identified, or the bottle 1 in the example here, is scanned on its surface. In principle, the entire surface of the object can be scanned. In the example here, however, only a part surface 8 of the object or of the bottle 1 is examined. In this case, the part surface 8 is dimensioned such that its size is sufficient for a unique identification of the object or of the bottle 1 to be produced. In the example in question the part surface 8 may be ca. 1 cm².

Characteristic digital values are derived from the result of the scanning of the surface of the object or of the bottle 1 and are indicated in FIG. 1. The digital values are combined to form a key.

In detail, the scanning unit 2, 3, 4, 5, as shown in FIG. 2, is made up by a laser or a laser diode 2 or a comparable coherent light source as well as a beam splitting lens or a beam splitter 3, an interference device 4 and finally a sensor 5. The light emitted by the laser or the laser diode 2 is thrown onto the object or the bottle 1 to be examined and is reflected on its surface on account of the surface roughness there quasi in practically all directions.

By means of the beam splitter 3 and the interference device 4, the light emitted by the laser diode 2 and the reflected light are superimposed and generate an interference pattern on the sensor 5. Information on the angle of the light beam reflected by the surface of the bottle 1 can be derived from the interference pattern. The angle of the reflected light is a measurement for the surface roughness R, as is represented schematically in FIG. 3 for individual points x on the part surface 8.

At all events, by means of said contact-less scanning method the surface of the object or bottle 1 examined, with respect to its roughness or surface roughness R, can be recorded as a function of the respective site x. At the same time, the respective roughness R of the natural surface of the bottle 1 is examined and detected. This occurs in the present case by means of a conoscopic holography device as scanning unit 2, 3, 4, 5. Further details on conoscopic holography can be found, for example, in the article by K. Buse et al. entitled “3D Imaging: Wave Front Sensing Utilizing a Birefringent Crystal”, Physical Review Letters, The American Physical Society, Vol. 85, 16/2000, pages 2285-3387, to which reference is expressly made.

At all events, by means of the scanning unit 2, 3, 4, 5, the roughness R of the part surface 8 of the bottle 1 can be determined as a function of the respective position x, as is represented in FIG. 3. This can also be carried out by contact, that is to say by means of a tactile scanning unit 2, 3, 4, 5, but this is not represented. In one way or another, the roughness values are converted by means of the identification device 6 into digital values, which are characteristic of the part surface 8 or of the overall surface of the bottle 1. This is illustrated in FIG. 1.

Over above this, the identification device 6 connected to the sensor 5 of the scanning unit 2, 3, 4, 5 derives a result from the digital values obtained in such a manner, said result being combined to form a key. In the simplest case, therefore, the roughness profile of the part surface 8 of the bottle 1 corresponds to a digital key 9, 10, as represented in FIG. 1, which is 256 bits or more in size. Said key 9, 10 represents the so-called reference key 9 of the object or of the bottle 1 examined in the example here. The reference key 9 indicated in FIG. 1 can be stored in a data base (not shown). In addition, it is also possible to store the reference key 9 on the object or bottle 1 examined. To this end, the bottle 1 may be provided with a correspondingly developed label, which contains the reference key 9, for example in the form of a barcode.

If the originality of the object or the bottle 1 in the example here then has to be investigated, the part surface 8 of the bottle 1 is scanned. In this case, the part surface 8 must obviously be the same part surface 8 that was used beforehand for determining the reference key 9. This means that the position of the part surface 8 of the object or of the bottle 1 to be examined that was used for determining the key must be established along with the size thereof. In other words, the position and extent of the part surface 8 must be specified. This data can be stored together with the reference key 9. Over and above this, the reference key 9 may be flanked by the date it was created, the place of manufacture of the bottle 1 in the example here, the place of manufacture, its batch number etc. This means the reference key 9, in the example here, contains not only specifications on the roughness R inside the part surface 8, but also gives additional information on the position and extent of the part surface 8 and the abovementioned data such as year of manufacture, place of manufacture, etc.

If, then, the position and extent of the part surface 8 are established, by using a scanning unit 2, 3, 4, 5, the part surface 8 of a bottle 1 to be examined can be scanned exactly as was already the case for determining the reference key 9. A check key 10, also indicated in FIG. 1, results from this process. The reference key 9 and the check key 10 are then examined in the comparator 7 to see whether or not there is a match.

To this end, the degree of the match between the reference key 9 and the check key 10 is determined with consideration to a predetermined value, in the example here with additional consideration to the so-called hamming distance 11. This refers to the number of bits that can deviate in the example here, as is indicated in FIG. 1.

This means that the two keys, on the one hand the check key 10 and on the other hand the reference key 9, are evaluated as matching with consideration to the predetermined hamming distance 11 stored in the comparator 7. As a result of this, the bottle 1 is detected as an original bottle and the originality test leads to a positive result. It can be seen that the reference key 9 is stored in a label 12 on the bottle 1.

1. A method for identifying objects, said method comprising:
scanning at least part of a surface of an object;
deriving at least one result from the scanning;
converting the at least one result into characteristic digital values representative of a natural surface of the object; and combining the characteristic digital values together to form at least one key.

2. The method of claim 1, further comprising storing the key is stored in an external data base as a reference key.

3. The method of claim 1, further comprising attaching the key to the identified object as a reference key.

4. The method of claim 3, further comprising checking the reference key is for a match with a check key derived from identification of the object.

5. The method of claim 4, further comprising determining that a degree of a match between the check key and the reference key exceeds a predetermined value.

6. The method of claim 1, wherein scanning a part of the surface of the object is comprises scanning in a contactless manner.

7. The method of claim 1, further comprising obtaining a measurement of the surface characteristics of the surface.

8. An apparatus for identifying an object having a natural surface, said apparatus comprising:
a scanning unit for scanning at least a part of a surface of the object; and
an identification device for deriving at least one result from data obtained from the scanning unit, the result representing the natural surface of the object,
converting the result into characteristic digital values, and combining the values to form at least one key.

9. The apparatus of claim 8, wherein the scanning unit comprises a tactile unit.

10. The apparatus of claim 8, wherein the scanning unit comprises a contactless scanning unit.

11. The apparatus of claim 8, further comprising a comparator for comparing a reference key of an object already scanned with a check key derived from an object currently being examined.

12. The apparatus of claim 11, wherein the comparator assesses the match between the reference key and the check key taking a predetermined tolerance into consideration.

13. The apparatus of claim 8, further comprising a label that contains the reference key.

14. (canceled)

15. (canceled)

16. The method of claim 1, further comprising selecting the object to be a bottle.

17. The method of claim 1, further comprising selecting the object to be a consumer good.

18. The method of claim 1, further comprising selecting the object to be a machine or a part thereof.

19. The method of claim 1, wherein scanning a part of the surface of the object comprises contacting the part of the surface.

20. The method of claim 7, wherein obtaining a measurement comprises evaluating of at least one of: the object's structural conditions, surface finish, colour, reflection behaviour, transparency, strength, ohmic or capacitive resistance, and chemical characteristics.

21. The apparatus of claim 9, wherein the tactile unit comprises a stylus instrument.

22. The apparatus of claim 10, wherein the contactless scanning unit comprises an optical scanning unit for contactless measurement of deviations in at least one of form and shape.

23. The apparatus of claim 10, wherein the contactless scanning unit comprises a conoscopic holography device.
